(19) United States
(12) Patent Application Publication
(10) Pub. No.: US 2021/0287091 A1
(43) Pub. Date: Sep. 16, 2021

(54) NEURAL NETWORK TRAINING METHOD AND IMAGE MATCHING METHOD AND APPARATUS

(71) Applicant: SHENZHEN SENSETIME TECHNOLOGY CO., LTD., Shenzhen (CN)

(72) Inventors: Yuying GE, Shenzhen (CN); Lingyun WU, Shenzhen (CN); Ruimao ZHANG, Shenzhen (CN); Ping LUO, Shenzhen (CN)

(73) Assignee: SHENZHEN SENSETIME TECHNOLOGY CO., LTD., Shenzhen (CN)

(21) Appl. No.: 17/337,343

(22) Filed: Jun. 2, 2021

Related U.S. Application Data
(63) Continuation of application No. PCT/CN2019/114449, filed on Oct. 30, 2019.

(30) Foreign Application Priority Data
Dec. 14, 2018 (CN) 201811535420.4

(51) Int. Cl. G06N 3/08; G06K 9/00; G06K 9/62

(52) U.S. Cl. CPC G06N 3/08; G06K 9/00671; G06K 9/6256; G06K 9/6232; G06K 9/6215

(57) ABSTRACT

A neural network training method and apparatus and an image matching method and apparatus are provided. The neural network training method at least includes: labeling annotation information of a first clothing instance and a second clothing instance, where the first clothing instance and the second clothing instance are respectively from a first clothing image and a second clothing image; pairing the first clothing image and the second clothing image in response to a state of matching between the first clothing instance and the second clothing instance; and training a neural network to be trained based on the paired first clothing image and second clothing image.

### CROSS-REFERENCE TO RELATED APPLICATIONS

This is a continuation application of International Patent Application No. PCT/CN2019/114449, filed on Oct. 30, 2019, which claims priority to the Chinese Patent Application No. 201811535420.4 filed on Dec. 14, 2018. The disclosures of the above applications are incorporated herein by reference in their entirety.

### BACKGROUND

Clothing image analysis has become a hot research field in recent years due to its huge potential in academia and industry. However, in practical applications, clothing understanding still faces many challenges. For example, in terms of data, the clothing dataset (DeepFashion) has become the largest existing clothing dataset, but DeepFashion has its own defects. For example, each image contains only an annotation of a single clothing instance. The difference between a such defined benchmark dataset and an actual situation may seriously affect the application of clothing understanding.

### SUMMARY

The present application relates to clothing image analysis technologies, and in particular, to a neural network training method and apparatus and an image matching method and apparatus.

Embodiments of the present application provide a neural network training method and apparatus, an image matching method and apparatus, a storage medium, a computer program product, and a computer device.

The neural network training method provided in the embodiments of the present application includes the following operations. Annotation information of a first clothing instance and a second clothing instance are labeled, where the first clothing instance and the second clothing instance are respectively from a first clothing image and a second clothing image. The first clothing image and the second clothing image are paired in response to a state of matching between the first clothing instance and the second clothing instance. A neural network to be trained is trained based on the paired first clothing image and second clothing image.

The image matching method provided in the embodiments of the present application includes the following operations. A third clothing image to be matched is received. A third clothing instance is extracted from the third clothing image. Annotation information of the third clothing instance is acquired. A matched fourth clothing instance is queried based on the annotation information of the third clothing instance.

The neural network training apparatus provided in the embodiments of the present application includes an labeling module and a training module.

The labeling module is configured to label annotation information of a first clothing instance and a second clothing instance, where the first clothing instance and the second clothing instance are respectively from a first clothing image and a second clothing image, and to pair the first clothing image and the second clothing image in response to a state of matching between the first clothing instance and the second clothing instance.

The training module is configured to train a neural network to be trained based on the paired first clothing image and second clothing image.

The image matching apparatus provided in the embodiments of the present application includes a receiving module, an extracting module and a matching module.

The receiving module is configured to receive a third clothing image to be matched.

The extracting module is configured to extract a third clothing instance from the third clothing image and to acquire annotation information of the third clothing instance.

The matching module is configured to query a matched fourth clothing instance based on the annotation information of the third clothing instance.

The storage medium provided in the embodiments of the present application stores has a computer program stored thereon, where after being executed by a computer device, the computer program can implement the neural network training method or the image matching method.

The computer program product provided in the embodiments of the present application includes computer executable instructions, where after being executed, the computer executable instructions can implement the neural network training method or the image matching method.

The computer device provided in the embodiments of the present application includes a memory and a processor, where the memory stores computer executable instructions, and when running the computer executable instructions on the memory, the processor can implement the neural network training method or the image matching method.

### BRIEF DESCRIPTION OF DRAWINGS

FIG. 1 is a schematic flowchart of an image dataset labeling method provided in the embodiments of the present application.

FIG. 2 is a schematic diagram of categories and related annotations of clothing images provided in the embodiments of the present application.

FIG. 3 is an schematic flowchart of a neural network training method provided in the embodiments of the present application.

FIG. 4 is a Match R-CNN framework diagram provided in the embodiments of the present application.

FIG. 5 is a schematic flowchart of an image matching method provided in the embodiments of the present application.

FIG. 6 is a schematic structural composition diagram of a neural network training apparatus provided in the embodiments of the present application.

FIG. 7 is a schematic structural composition diagram of an image matching apparatus provided in the embodiments of the present application.

FIG. 8 is a schematic structural composition diagram of a computer device according to the embodiments of the present application.

### DETAILED DESCRIPTION

In the technical solutions in the embodiments of the present application, a constructed image dataset is a large-scale benchmark dataset having comprehensive annotations. By labeling all clothing instances existing in one single image, a more comprehensive clothing dataset is provided for the development and application of a clothing analysis algorithm, thereby promoting the application of clothing understanding. On the other hand, by means of an end-to-end deep clothing analysis framework, acquired clothing images can be directly used as inputs, and a clothing instance retrieval task can be implemented. The framework is universal and is suitable for any deep neural network and other target retrieval tasks.

Various exemplary embodiments of the present application are now described in detail with reference to the accompanying drawings. It should be noted that, unless otherwise stated specifically, relative arrangement of the components and operations as well as the numerical expressions and the values set forth in embodiments are not intended to limit the scope of the present application.

In addition, it should be understood that, for ease of description, the size of each part shown in the accompanying drawings is not drawn in actual proportion.

The following descriptions of at least one exemplary embodiment are merely illustrative actually, and are not intended to limit the present application and applications or uses thereof.

Technologies, methods and devices known to persons of ordinary skill in the related art may not be discussed in detail, but such technologies, methods and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

Embodiments of the present application are applicable to an electronic device such as a computer system/server, which may operate with numerous other general-purpose or special-purpose computing system environments or configurations. Examples of well-known computing systems, environments, and/or configurations suitable for use together with electronic devices such as the computer systems/servers include, but are not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing environments that include any one of the preceding systems, and the like.

The electronic devices such as the computer systems/servers may be described in general context of computer system executable instructions (for example, program modules) executed by the computer systems. Generally, the program modules may include routines, programs, target programs, components, logics, data structures, and the like for executing specific tasks or implementing specific abstract data types. The computer systems/servers may be implemented in distributed cloud computing environments in which tasks are executed by remote processing devices that are linked by a communications network. In the distributed cloud computing environments, the program modules may be located in local or remote computing system storage media including storage devices.

In the process of implementing the present application, the applicant found out through research that clothing understanding still faces many challenges, and at least the following problems exist:

1) Data: first, clothes change a lot in style, texture, tailoring, and the like, and there are different degrees of deformation and blocking in a single piece of clothing. Second, a same piece of clothing varies greatly in different photographing scenes, such as a selfie image of a consumer (buyer feedback) and an online business image (seller display). Previous studies attempt to address these challenges by annotating clothing datasets by using semantic attributes, clothing positions, or cross-domain solutions, but different datasets are annotated by different types of information. The annotations above are not unified to form the largest clothing dataset until the appearance of the DeepFashion datasetHowever, DeepFashion has its own defects. For example, each image comprises only the annotation of a single piece of clothing, but each clothing category shares 8 sparse key point marks, and has no fine segmentation mask annotation. The difference between a such defined benchmark dataset and the actual situation may seriously affect the application of clothing understanding.

2) Task definition: first, various tasks, such as clothing detection and recognition, key point prediction, clothing segmentation, and clothing matching and retrieval, have appeared in recent years to analyze clothing images. However, in view of the characteristics of clothing such as different degrees of changes, easy deformation, and multiblockings, there is a lack of a broader and more unified evaluation benchmark to define and explain all the tasks above. Second, in the past, key point marks of the clothing are defined according to contours of human skeletons, and are merely divided into tops and bottoms, which would inevitably affect the accuracy of key point prediction indicators. In addition, in actual situations, multiple types of clothing may exist in one single image, and a retrieval task defined based on the entire image would affect the clothing understanding ability of an algorithm.

3) Algorithm implementation: in order to better deal with the differences of clothing images in different scenes, previous methods have introduced deep models to learn more discriminative expressions, but the ignorance of the deformation and blockings in clothing images hinders the improvement of recognition accuracy. A deep model, FashionNet, is specifically designed for a clothing recognition and retrieval task by the work of DeepFashion, so as to achieve more discerning clothing analysis by means of features comprehensively learned by predicting clothing key points and attributes. However, FashionNet has two obvious defects: first, a clothing classification and retrieval task implemented thereby uses manually marked bounding box cropped sub-images as inputs rather than directly using acquired images as inputs, such that the labeling costs in an actual application process are greatly increased. Second, the use of distance constraint between positive and negative samples to implement the clothing retrieval task cause poor versatility due to the strong dependence on samples, and thus cause difficult convergence in an actual training process.

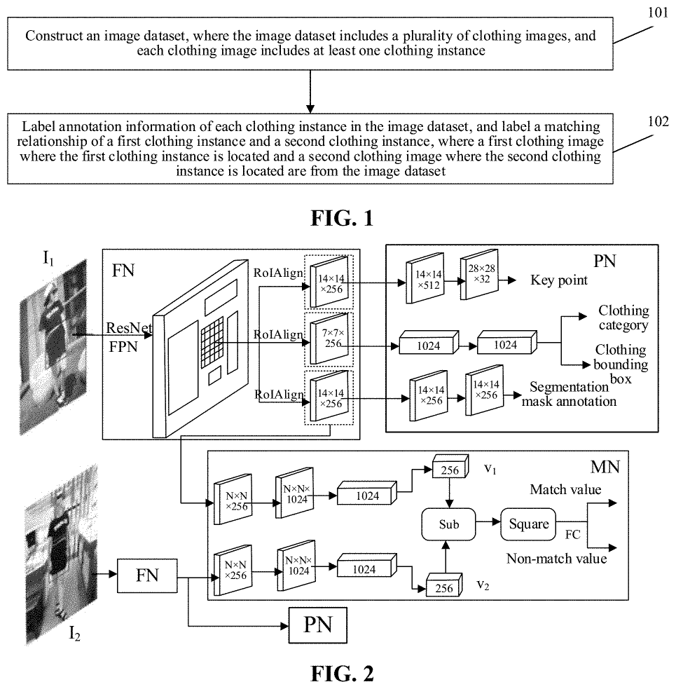

FIG. 1 is a schematic flowchart of an image dataset labeling method provided in the embodiments of the present application. As shown in FIG. 1, the image dataset labeling method includes the following operations.

At operation 101, an image dataset is constructed, where the image dataset includes a plurality of clothing images, and each clothing image includes at least one clothing instance.

In an optional embodiment of the present application, the constructed image dataset is a standard dataset (called DeepFashion2) that has rich annotation information and is suitable for a wide range of clothing image analysis tasks, where the image dataset includes a plurality of clothing images, and each clothing image includes one or more clothing instances. The clothing instance here refers to a piece of clothing in a clothing image. It should be noted that one clothing image may only display one or more pieces of clothing, or may display one or more pieces of clothing by human beings (i.e., models). Furthermore, there may be one or more human beings.

In one embodiment, the image dataset includes 491k (i.e., 491,000) clothing images, and the 491k clothing images include 801k (i.e., 801,000) clothing instances in total.

At operation 102, annotation information of each clothing instance in the image dataset is labeled, and a matching relationship between a first clothing instance and a second clothing instance is labeled, where a first clothing image where the first clothing instance is located and a second clothing image where the second clothing instance is located are both from the image dataset.

In the embodiments of the present application, each clothing instance in the image dataset is labeled with at least one of the following annotation information: a clothing category, a clothing bounding box, a key point, a clothing outline, and a segmentation mask annotation. Contents below describe how to label each annotation information.

1) Clothing category

The embodiments of the present application define 13 common clothing categories for the image dataset, including short-sleeved shirts, long-sleeved shirts, short-sleeved coats, long-sleeved coats, vests, camisoles, shorts, trousers, short skirts, short-sleeved dresses, long-sleeved dresses, vest dresses, and sling dresses.

The labeling of the clothing category of the clothing instance refers to classifying the clothing instance into one of the 13 clothing categories.

2) Clothing bounding box

In an optional embodiment of the present application, the clothing bounding box can be implemented by a rectangular box. The labeling of the clothing bounding box of the clothing instance refers to covering a display area of the clothing instance by a rectangular box.

3) Key point

In an optional embodiment of the present application, each clothing category has its own independent definition on dense key points, and different clothing categories correspond to different definitions on key points. It should be noted that different clothing categories correspond to different positions and/or numbers of key points. For example, referring to FIG. 4, a short-sleeved shirt defines 25 key points, a pair of shorts defines 10 key points, a long-sleeved coat defines 38 key points, and a short skirt defines 8 key points. The corresponding key points are labeled based on the clothing category of the clothing instance.

It should be noted that each clothing image may include one or more clothing instances, and the key points of the corresponding clothing category needs to be labeled for each clothing instance.

Furthermore, after the corresponding key points are labeled based on the clothing category of the clothing instance, attribute information of each key point is labeled, where the attribute information is used for indicating whether the key point is a visible point or a blocked point.

4) Clothing outline

In an optional embodiment of the present application, after labeling the key points of each clothing instance in the image dataset, it is also necessary to label edge points and intersection points for each clothing instance in the image dataset, where the edge points are points of the clothing instances on the boundaries of clothing images, and the intersection points are points located at positions where the clothing instances intersect other clothing instances and used for drawing the clothing outlines.

Then, the clothing outline is drawn based on the key points, the attribute information of each of the key point, the edge points, and the intersection points labeled for the clothing instance.

5) Segmentation mask annotation

In an optional embodiment of the present application, a preliminary segmentation mask map is generated based on clothing outlines, and the preliminary segmentation mask map is corrected to obtain the segmentation mask annotation.

In one embodiment, each clothing instance in the image dataset is labeled with at least one of the following annotation information:
size, which refers to the proportion of a clothing instance to a clothing image;
blocking, which refers to the proportion of blocked points in key points labeled in a clothing instance;
focus, which refers to the proportion of key points, in key points labeled in a clothing instance, that go beyond the range of the clothing image; and
viewing angle, which refers to the display angle of a clothing instance.

6) In the technical solutions in the embodiments of the present application, in addition to the annotation information above of each clothing instance, each clothing instance is also labeled with a product identifier and a clothing style.

The product identifier can be any combination of the following contents: letters, numbers, and symbols. The product identifier is used for identifying identical products. That is, product identifiers corresponding to identical products are the same. It should be noted that identical products are products having the same tailoring (i.e., style).Furthermore, clothing instances having the same product identifier may be different or the same in clothing styles, where the clothing styles here refer to colors, patterns, trademarks, and so on.

7) In the technical solutions in the embodiments of the present application, in addition to the annotation information of each clothing instance in the image dataset, a matching relationship between a first clothing instance and a second clothing instance is also labeled. In one example, the clothing image of the first clothing instance is from a buyer, and the clothing image of the second clothing instance is from a seller. The first clothing instance and the second clothing instance here are provided with identical product identifiers.

It should be noted that the technical solutions in the embodiments of the present application can label all the annotation above but are not limited thereto, and the technical solutions in the embodiments of the present application can also label part of the annotation information above.

The technical solutions in the embodiments of the present application are described below with examples.

An image dataset called DeepFashion2 is constructed, where the DeepFashion2 consists of 491k clothing images, and includes 13 clothing categories, 801k clothing instances, 801k clothing bounding boxes, 801k dense key points and corresponding outline marks, 801k pixel-level segmentation mask annotations, and matching relationships of clothing instances in 873k pairs of buyer feedback pictures and seller display pictures (here, each clothing instance in the buyer feedback pictures corresponds to the first clothing instance, and each seller display clothing instance corresponds to the second clothing instance),In addition, in order to cover the common deformation and blocking changes of clothing, each clothing instance is additionally labeled with four types of clothing attribute information, i.e., size, blocking, focus, and viewing angle. In addition, for different clothing instances of the same clothing product (having the same product identification), annotation information about clothing styles such as colors, patterns, and trademarks is added.DeepFashion2 is by far the most expressive and the most diverse clothing dataset having the largest amount of annotation information and the widest variety of tasks. Contents below describe how to label the annotation information in DeepFashion2.

1) Labeling of clothing categories and clothing bounding boxes

The 13 clothing categories in DeepFashion2 are selected from the previous clothing categories and defined by comparing the similarity and frequency statistics of different categories. The 13 common clothing categories include: short-sleeved shirts, long-sleeved shirts, short-sleeved coats, long-sleeved coats, vests, camisoles, shorts, trousers, short skirts, short-sleeved dresses, long-sleeved dresses, vest dresses, and sling dresses.

The labeling of a bounding box can be implemented by marking, by a labeler, coordinate points of an area where a target clothing instance is located.

2) Labeling of key points, clothing outlines, and segmentation mask annotations

The existing work defines the key points according to the structure of a human body. The tops and bottoms share the same key points regardless of the type of clothing. In the embodiments of the present application, considering that different clothing categories have different deformations and appearance changes, personalized key points and outlines are defined for each clothing category, and the concept of “clothes posture” is provided for the first time on the basis of “body posture”.

As shown in FIG. 2, the left side shows the definition of dense key points and clothing outlines of 4 different clothing categories, and the right side shows the corresponding seller display and buyer feedback pictures as well as annotation information. In FIG. 2, a pair of clothing instances in each row of seller display and buyer feedback pictures have identical product identifier, but the clothing instances have different clothing styles such as colors and patterns and show different levels in the 4 attributes, i.e., size, blocking, focus, and viewing angle. Each clothing instance is labeled with key points, outlines, and segmentation mask annotations. It should be noted that the product identifier may be any combination of the following contents: letters, numbers, and symbols. The product identifier is used for identifying identical products. That is, product identifiers corresponding to identical products are the same. It should be noted that identical products are products that have the same tailoring (i.e., type). Furthermore, clothing instances having identical product identifier may be different or the same in clothing styles.

A labeling process is divided into the following five operations.

I: For each clothing instance, all key points defined by the clothing category are labeled, where each clothing category includes 22 key points on average;

II: The attribute of each key point that can be labeled needs to be marked, i.e., where the key point is visible or blocked;

III: In order to assist the segmentation, in addition to the key points, two types of mark points, i.e., edge points and intersection points, are added, where the former represents the points of the clothing instances on the boundary of a picture, and the latter represents points, at positions where the clothing instance or the second clothing instance intersects other clothing instances, which are not key points but are used for drawing a clothing outline, such as “points at positions where a T-shirt intersects a bottom in that case that the T-shirt is tucked into the bottom”.

IV: A clothing outline is generated by performing automatic connection on the basis of integrated information of key points, key point attributes, and edge points and intersection points, where on one hand, the clothing outline is used for detecting whether the mark points are reasonable, and on the other hand, the clothing outline is used as a preliminary segmentation mask map to reduce the costs of segmentation labeling.

Here, the dressing effect of clothes on a model needs to satisfy a normal dressing logic. When a variety of clothes are worn on a model, there are intersections between clothes. For example, a top is worn on the upper part of the body and a bottom is worn on the lower part of the body, the top can be tucked into the bottom or can cover a part of the bottom, and the intersections between the top and the bottom is labeled with mark points. On this basis, whether the mark points used for drawing a clothing outline are reasonable can be determined by detecting whether the drawn clothing outline satisfies the normal dressing logic. Furthermore, if the mark points are unreasonable, the unreasonable marked points can be corrected, i.e., adjusting the positions of the marked points or deleting the mark points until the finally drawn clothing outline satisfies the normal dressing logic.

V: The preliminary segmentation mask map is further checked and corrected to obtain the final segmentation mask annotation.

The segmentation mask maps here are binary maps. In the binary maps, the areas formed by the clothing outline are assigned to be true (for example, “1” represents true), and the remaining areas are assigned to be false (for example, “0” represents false).The segmentation mask maps show the overall outlines of the clothing instances. Considering that one or more key points may be incorrectly labeled during a key point labeling process, resulting in that the segmentation mask map is partially deformed compared with normal clothing categories (such as short-sleeved tops, shorts, short skirts), it is necessary to check the segmentation mask map to find out the incorrect key point and correct the incorrect key point, i.e., adjusting the position of the key point or deleting the key point. It should be noted that after correcting the segmentation mask map, the segmentation mask annotation can be obtained.

3) Labeling of clothing attributes

In order to cover all of clothing changes, four clothing attributes, i.e., size, blocking, focus, and viewing angle, are added for each clothing instance, where each attribute is divided into three levels.

Size collects the statistics about the proportion of the clothing instance in the entire picture and is divided into three levels, i.e., small (<10%), medium (>10% and <40%), and large (>40%).

Blocking collects the statistics about the proportion of blocked points in the key points and is divided into three levels, i.e., no blocking, severe blocking (>50%), and partial blocking (<50%.

Focus collects the statistics about the proportion of points outside the picture range among the key points and is divided into three levels, i.e., no focus, large focus (>30%), and intermediate focus (<30%).

Viewing angle is divided into modelless display, front display, and back display based on clothing display viewing angles.

4) Labeling of clothing styles

In the matching of 873k pairs of buyer feedback and seller display clothing instances, there are 43.8k clothing instances having different product identifiers, and each product identifier corresponds to 13 clothing instances on average, where these clothing instances having identical corresponding product identifiers are added with annotations of clothing styles, such as colors, patterns, and trademarks. As shown in FIG. 2, each row represents clothing instances corresponding to the same corresponding product identifier, where different clothing styles are represented by annotations in different colors.

In the technical solutions in the embodiments of the present application, each clothing image include one or more clothing instances, and each clothing instance has 9 types of annotation information, including style, size, blocking, focus, viewing angle, bounding box, dense key points and outlines, pixel-level segmentation mask annotations, and the matching relationship between identical clothing instances from buyer feedback and seller display. These comprehensive annotations support the tasks for understanding clothing images, and DeepFashion2 is by far the most comprehensive clothing dataset.

On the basis of DeepFashion2, the present application independently defines a set of comprehensive clothing image analysis task evaluation criteria, including clothing detection and recognition, clothing key point and clothing outline estimation, clothing segmentation, and instance-level buyer feedback and seller display-based clothing retrieval, which are specifically as follows:

1) Clothing detection and recognition

This task is to detect the positions of all clothing instances in an input image and recognize corresponding clothing categories, and the evaluation index of this task is the same as that of a general target detection task.

2) Clothing key point and clothing outline estimation

Clothing key point and clothing outline estimation is to perform key point prediction and clothing outline estimation on all clothing instances detected in the input image. For the evaluation index of clothing key point and clothing outline estimation, please refer to the evaluation index of a human body key point prediction task. Each clothing category has respective corresponding key points.

3) Clothing segmentation

Clothing segmentation is to segment all clothing instances detected in the input image and automatically obtain pixel-level segmentation mask annotations, and the evaluation index of clothing segmentation is the same as that of a general target segmentation task.

4) Instance-level buyer feedback and seller display-based clothing retrieval

Instance-level buyer feedback and seller display-based clothing retrieval is to retrieve, for known buyer feedback images, seller display images matching the detected clothing instances. This task differs from previous work by directly taking photos taken by buyers as inputs, without providing the bounding box information of the clothing instances. Here, since the neural network of the embodiments of the present application can extract information such as bounding boxes of clothing instances from the photos taken by buyers, the photos taken by buyers can be used directly as inputs to the neural network, without providing bounding box information of clothing instances to the neural network.

The technical solutions in the embodiments of the present application independently define a set of comprehensive clothing image analysis task evaluation criteria, including clothing detection and recognition under various clothing attribute changes, key point prediction and clothing outline estimation, clothing segmentation, and instance-level buyer feedback and seller display-based clothing retrieval. These tasks are the basic tasks for clothing image understanding and can be used as benchmarks for a subsequent clothing analysis task. By means of these evaluation benchmarks, direct comparison can be made between different algorithms, and advantages and disadvantages to the algorithms can be deeply understood, so as to promote the cultivation of a more powerful clothing analysis system having high robustness.

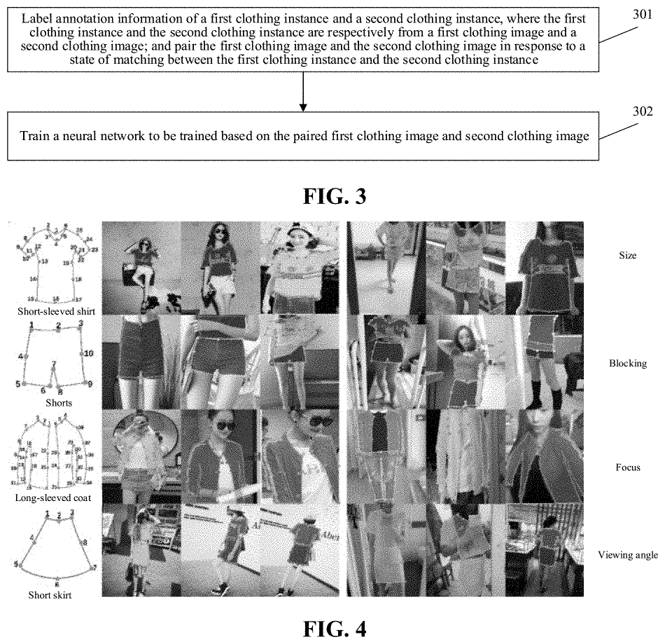

FIG. 3 is an schematic flowchart of a neural network training method provided in the embodiments of the present application. As shown in FIG. 3, the neural network training method includes the following operations.

At operation 301, annotation information of a first clothing instance and a second clothing instance are labeled, where the first clothing instance and the second clothing instance are respectively from a first clothing image and a second clothing image, and the first clothing image and the second clothing image are paired in response to a state of matching between the first clothing instance and the second clothing instance.

In the embodiments of the present application, the first clothing image may be from a buyer or a seller, and the second clothing image may be also from a buyer or a seller. For example, the first clothing image is from a buyer, and the second clothing image is from a seller; or the first clothing image is from a seller, and the second clothing image is from a buyer; or the first clothing image is from a seller, and the second clothing image is from a seller; or the first clothing image is from a buyer, and the second clothing image is from a buyer.

In an optional embodiment of the present application, the first clothing image and the second clothing image may be directly selected from the image dataset in the method shown in FIG. 1, where the first clothing image at least includes a first clothing instance, the second clothing image at least includes a second clothing instance, each clothing instance in the first clothing image and the second clothing image is separately labeled with annotation information, and the first clothing instance and the second clothing instance are labeled as matching. Alternatively, the first clothing image and the second clothing image are not selected from the image dataset in the method shown in FIG. 1. In this case, it is necessary to label the annotation information of the first clothing instance and the second clothing instance and label the matching relationship between the first clothing instance and the second clothing instance. Specifically, the first clothing instance and the second clothing instance can be labeled according to the method shown in FIG. 1. Contents below describe how to label the annotation information of the first clothing instance and the second clothing instance.

1) Clothing bounding boxes of the first clothing instance and the second clothing instance are respectively labeled.

The clothing bounding box here may be implemented by a rectangular box. The labeling of a clothing bounding box of a clothing instance is to cover a display area of the clothing instance by a rectangular box. It should be noted that the clothing bounding box in the embodiments of the present application is not limited to a rectangular box, and may also be a bounding box of other shapes, such as an oval bounding box and an irregularly polygonal bounding box. The clothing bounding box integrally reflects the display area of a clothing instance in a clothing image.

2) The clothing categories and the key points of the first clothing instance and the second clothing instance are respectively labeled.

2.1) Labeling of clothing categories

The embodiments of the present application define 13 common clothing categories, including short-sleeved shirts, long-sleeved shirts, short-sleeved coats, long-sleeved coats, vests, camisoles, shorts, trousers, short skirts, short-sleeved dresses, long-sleeved dresses, vest dresses, and sling dresses.

The labeling of the clothing categories of the clothing instances is to classify the clothing instances into one of the 13 clothing categories.

2.2) Labeling of key points

In the embodiments of the present application, the clothing categories of the first clothing instance and the second clothing instance are respectively obtained, and the corresponding key points of the first clothing instance and the second clothing instance are respectively labeled on the basis of a labeling rule of the clothing categories.

Specifically, each clothing category has its own independent definition of dense key points, and different clothing categories correspond to different key point definitions. It should be noted that the positions and/or numbers of key points corresponding to different clothing categories are different. For example, referring to FIG. 4, a short-sleeved shirt defines 25 key points, a pair of shorts defines 10 key points, a long-sleeved coat defines 38 key points, and a short skirt defines 8 key points. The corresponding key points are labeled based on the clothing categories of the clothing instances.

Furthermore, after the clothing categories and the key points of the first clothing instance and the second clothing instance are respectively labeled, attribute information of each key point is labeled, where the attribute information is used for indicating whether the key point is a visible point or a blocked point. The visible point here is a key point that can be viewed, and the blocked point is a key point that is blocked by other clothes or objects or limbs and cannot be viewed.

Furthermore, after the clothing categories and the key points the first clothing instance and the second clothing instance are respectively labeled, edge points and intersection points of the first clothing instance and the second clothing instance are respectively labeled, where the edge points are points of the clothing instances on the boundaries of clothing images, and the intersection points are points located at positions where the first clothing instance or the second clothing instance intersects other clothing instances and used for drawing the clothing outlines.

Here, when a variety of clothes are worn on a model, there are intersections between clothes. For example, a top is worn on the upper part of the body and a bottom is worn on the lower part of the body, the top can be tucked into the bottom or can cover a part of the bottom, and the intersections between the top and the bottom is labeled with intersection points.

3) Clothing outlines and segmentation mask annotations of the first clothing instance and the second clothing instance are respectively labeled.

3.1) Labeling of clothing outlines

Clothing outlines of the first clothing instance and the second clothing instance are respectively drawn respectively based on the key points, the attribute information of each of the key points, the edge points, and the intersection points of the first clothing instance and the second clothing instance.

3.2) Labeling of segmentation mask annotations

Corresponding preliminary segmentation mask maps are respectively generated based on the clothing outlines of the first clothing instance and the second clothing instance, and the preliminary segmentation mask maps are corrected to obtain segmentation mask annotations.

The segmentation mask map here is a binary map. In this binary map, the area formed by the clothing outline is assigned to be true (for example, “1” represents true), and the remaining areas are assigned to be false (for example, “0” represents false).The segmentation mask map shows the overall outlines of the clothing instance. Considering that one or more key points may be incorrectly labeled during a key point labeling process, resulting in that the segmentation mask maps are partially deformed compared with normal clothing categories (such as short-sleeved tops, shorts, and short skirts), it is necessary to check the segmentation mask maps to find out the incorrect key point, and correct the incorrect key point, i.e., adjusting the position of the key point or deleting the key point. It should be noted that after correcting the segmentation mask maps, the segmentation mask annotations can be obtained.

4) Labeling of a matching relationship

Identical product identifiers are provided for the first clothing instance and the second clothing instance to implement the pairing between the first clothing image and the second clothing image.

The product identifier here may be any combination of the following contents: letters, numbers, and symbols. The product identifier is used for identifying identical products. That is, product identifiers corresponding to identical products are the same. It should be noted that identical products are products having the same tailoring (i.e., type).Furthermore, clothing instances having the same product identifier may be different or the same in clothing styles, where the clothing styles here refer to colors, patterns, trademarks, and so on.

At operation 302, a neural network to be trained is trained based on the paired first clothing image and second clothing image.

In the embodiments of the present application, a novel deep clothing analysis framework, i.e., Match R-CNN, is provided. The neural network is based on Mask R-CNN, directly takes acquired clothing images as inputs, combines all the features learned from the clothing categories, dense key points and pixel-level segmentation mask annotations, and simultaneously solves, in end-to-end fashion, four clothing analysis tasks: 1) clothing detection and recognition; 2) clothing key points and clothing outline estimation; 3) clothing segmentation; and 4) instance-level buyer feedback and seller display-based clothing retrieval.

In an optional embodiment of the present application, the neural network (called Match R-CNN) includes a first feature extraction network, a first perception network, a second feature extraction network, a second perception network, and a matching network. The first feature extraction network and the second feature extraction network have the same structure and are collectively referred to as FN (Feature Network).The first perception network and the second perception network have the same structure and are collectively referred to as PN (Perception Network).The matching network is referred to as MN (Matching Network).The first clothing image is directly input to the first feature extraction network, and the second clothing image is directly input to the second feature extraction network. The output of the first feature extraction network is taken as the input of the first perception network, and the output of the second feature extraction network is taken as the input of the second perception network. In addition, both the output of the first feature extraction network and the output of the second feature extraction network are taken as the input of the matching network. Specifically,
the first clothing image is input to the first feature extraction network for processing so as to obtain first feature information, the first feature information is input to the first perception network for processing so as to obtain annotation information of the first clothing instance in the first clothing image, and the first clothing image is from a buyer.

The second clothing image is input to the second feature extraction network for processing so as to obtain second feature information, the second feature information is input to the second perception network for processing so as to obtain annotation information of the second clothing instance in the second clothing image, and the second clothing image is from a seller.

The first feature information and the second feature information are input to the matching network for processing so as to obtain a matching result between the first clothing instance and the second clothing instance.

In the embodiments of the present application, during the training of the neural network, key point estimation cross-entropy loss values corresponding to the key points, clothing classification cross-entropy loss values corresponding to the clothing categories, bounding box regression smoothing loss values corresponding to the clothing bounding boxes, and clothing segmentation cross-entropy loss values corresponding to the segmentation mask annotations, and the clothing retrieval cross-entropy loss values corresponding to the matching results, are simultaneously optimized.

The technical solutions in the embodiments of the present application are described below with examples.

Referring to FIG. 4, FIG. 4 is a framework diagram of Match R-CNN, which takes a buyer feedback picture I₂ and a seller display picture I₂ as input, and each input image passes through three main sub-networks, i.e., FN, PN, and MN. The structures of the FN and PN through which the seller display picture I₂ passes are simplified in FIG. 4. It should be noted that the structures of the FN and PN through which the seller display picture I₂ passes is the same as the structures of the FN and PN through which the buyer feedback picture I₁ passes. Specifically:

1) FN includes a main network module, i.e., a Residual Network-Feature Pyramid Network (ResNet-FPN), a candidate box extraction module (Region Proposal Network, RPN), and Region of Interest Alignment modules (ROIAlign).The input image is first input to the ResNet of the main network module to extract features from bottom to top, then upsampling from top to bottom and horizontal connection is performed by the FPN to construct a feature pyramid, then candidate boxes are extracted by RPN, and the features of each level of candidate boxes are obtained by ROIAlign.

2) PN includes three branches: key point estimation, clothing detection, and segmentation prediction. The candidate box features extracted by FN are respectively input to the three branches of PN. The key point estimation branch contains 8 convolution layers and 2 deconvolution layers for predicting key points of a clothing instance. The clothing detection branch consists of two shared full connection layers, i.e., a full connection layer for final category prediction and a full connection layer for bounding box regression prediction. The segmentation prediction branch consists of 4 convolution layers, 1 deconvolution layer, and 1 convolution layer for pixel-level segmentation map prediction.

3) MN contains a feature extraction module and a similarity learning module for clothing retrieval. The candidate frame features extracted by FN have strong discrimination capabilities in terms of clothing categories, outlines, and mask segmentation. In the embodiments of the present application, the feature extraction module respectively obtains feature vectors v₁ and v₂ corresponding to the pictures I₁ and I₂ by using the candidate box features of the two pictures extracted in the FN stage, and inputs the square of the difference between said feature vectors to the full connection layers for evaluation as the estimation determination of the similarity between the two clothing instances.

The parameters of the Match R-CNN are jointly optimized by 5 loss functions, i.e.,

min_{Θ}L=λ₁L_{cls}+λ₂L_{box}+λ₃Lₚₒₛₑ+λ₄Lₘₐₛₖ+λ₅Lₚₐᵢᵣ,

where L_{cls} is the clothing classification cross-entropy loss value, L_{box} is the bounding box regression smoothing loss value, Lₚₒₛₑ is the key point estimation cross-entropy loss value, Lₘₐₛₖ is the clothing segmentation cross-entropy loss value, and Lₚₐᵢᵣ is the clothing retrieval cross-entropy loss value. The definitions of L_{cls}, L_{box}, Lₚₒₛₑ, and Lₘₐₛₖ is the same as that of the Mask R-CN network, and

$${L}_{pair} = - \frac{1}{n} {\sum }_{i = 1}^{n} [ {y}_{i} log ( {\hat{y}}_{i} ) + ( 1 - {y}_{i} ) log ( 1 - {\hat{y}}_{i} ) ] ,$$

where yᵢ=1 indicates that the two clothing instances are matched (having the same product identifier), or otherwise, yᵢ=0 indicates that two clothing instances are not matched (having different product identifiers).

The technical solutions in the embodiments of the present application provide a novel, universal, and end-to-end deep clothing analysis framework (Match R-CNN). The framework is based on Mask R-CNN, combines the features learned from the clothing categories, dense key points and pixel-level segmentation mask annotations, and can simultaneously solve a plurality of clothing image analysis tasks. Different from the previous clothing retrieval implementation, the framework can directly take acquired clothing images as inputs and implement the instance-level clothing retrieval task in end-to-end fashion for the first time. The framework is universal and is suitable for any deep neural network and other target retrieval tasks.

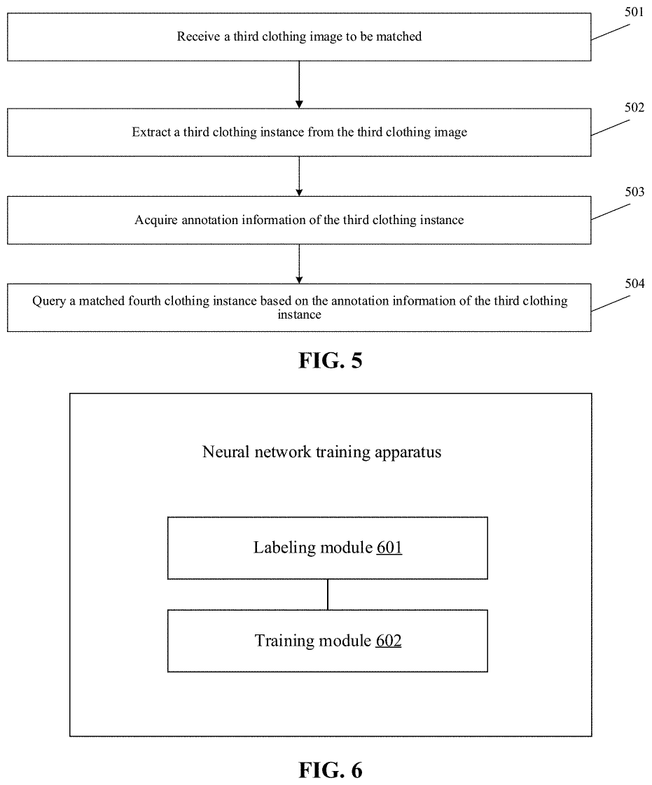

FIG. 5 is a schematic flowchart of an image matching method provided in the embodiments of the present application. As shown in FIG. 5, the image matching method includes the following operations.

At operation 501, a third clothing image to be matched is received.

In the embodiments of the present application, after the neural network is trained by using the method shown in FIG. 3, the neural network can be used for implementing clothing matching and retrieval. Specifically, the third clothing image to be matched is first input to the neural network. It should be noted that the third clothing image is not limited in source. It may be an image captured by a user himself/herself, an image downloaded by the user from the network, or the like.

At operation 502, a third clothing instance is extracted from the third clothing image.

In an optional embodiment of the present application, feature extraction needs to be performed on the third clothing image before extracting the third clothing instance from the third clothing image.

At operation 503, annotation information of the third clothing instance is acquired.

Specifically, the key point, clothing category, clothing bounding box, and segmentation mask annotation of the third clothing instance are acquired.

Referring to FIG. 4, the third clothing image I₁ and a clothing image I₂ to be queried are used as inputs, and each input image passes through three main sub-networks, i.e., FN, PN, and MN.FN is used for extracting the features of clothing images, PN is used for performing key point estimation, clothing category detection, and clothing bounding box and segmentation mask annotation prediction based on the features extracted by FN, and MN is used for performing similarity learning based on the features extracted by FN to implement the estimation determination of the similarity between the clothing instances.

The embodiments of the present application obtain feature vectors v₁ and v₂ corresponding to the pictures and I₁ and I₂ by using the features extracted from the two in the FN stage, and input the square of the difference between said feature vectors to the full connection layer as the evaluation determination of the similarity between the two clothing instances.

At operation 504, a matched fourth clothing instance is queried based on the annotation information of the third clothing instance.

In the embodiments of the present application, there is at least one closing instance to be queried, where these closing instances to be queried may be partially from one single clothing image and may all be from different clothing images. For example, there are 3 clothing instances to be queried, which are respectively from clothing image 1 (including 1 clothing instance) and clothing image 2 (including 2 clothing instances).

In an optional embodiment of the present application, similarity information between the third clothing instance and each clothing instance to be queried is determined based on the annotation information of the third clothing instance and the annotation information of the at least one clothing instance to be queried, and the fourth clothing instance matching the third clothing instance is determined based on the similarity information between the third clothing instance and the each clothing instance to be queried.

Specifically, referring to FIG. 4, the similarity value between clothing instance 1 and clothing instance 2 and the similarity value between clothing instance 1 and clothing instance 3 can be obtained by taking the third clothing image I₁ (including clothing instance 1) and the clothing image I₂ to be queried (including clothing instance 2 and clothing instance 3) as inputs, where the larger the similarity value, the greater the degree of matching, and the smaller the similarity value, the smaller the degree of matching. There may be one or more clothing images to be queried. On this basis, the similarity value between clothing instance 1 and each clothing instance to be queried can be obtained, and then the clothing instance having a similarity value greater than or equal to a threshold value is taken as the clothing instance matching the clothing instance 1 (i.e., the fourth clothing instance).Furthermore, the neural network can output an image where the fourth clothing instance is from.

FIG. 6 is a schematic structural composition diagram of a neural network training apparatus provided in the embodiments of the present application. As shown in FIG. 6, the apparatus includes:
a labeling module 601, configured to label annotation information of a first clothing instance and a second clothing instance, where the first clothing instance and the second clothing instance are respectively from a first clothing image and a second clothing image, and to pair the first clothing image and the second clothing image in response to a state of matching between the first clothing instance matches the second clothing instance; and
a training module 602, configured to train a neural network to be trained based on the paired first clothing image and the second clothing image.

In one embodiment, the labeling module 602 is configured to:
respectively label clothing bounding boxes of the first clothing instance and the second clothing instance.

In one embodiment, the labeling module 602 is configured to:
respectively label clothing categories and key points of the first clothing instance and the second clothing instance.

In one embodiment, the labeling module 602 is configured to:
respectively label clothing outlines and segmentation mask annotations of the first clothing instance and the second clothing instance.

In one embodiment, the labeling module 602 is configured to:
respectively acquire clothing categories of the first clothing instance and the second clothing instance; and
respectively label corresponding key points of the first clothing instance and the second clothing instance based on a labeling rule of clothing categories.

In one embodiment, the labeling module 602 is configured to:
label attribute information of each key point, where the attribute information is used for indicating whether the key point is a visible point or a blocked point.

In one embodiment, the labeling module 602 is configured to:
respectively label edge points and intersection points of the first clothing instance and the second clothing instance, where the edge points are points of the clothing instances on the boundaries of clothing images, and the intersection points are points located at positions where the first clothing instance or the second clothing instance intersects other clothing instances and used for drawing the clothing outlines.

In one embodiment, the labeling module 602 is configured to:
respectively draw the clothing outlines of the first clothing instance and the second clothing instance respectively based on the key points, the attribute information of each of the key points, the edge points, and the intersection points of the first clothing instance and the second clothing instance.

In one embodiment, the labeling module 602 is configured to:
respectively generate corresponding preliminary segmentation mask maps based on the clothing outlines of the first clothing instance and the second clothing instance; and
correct the preliminary segmentation mask maps to obtain the segmentation mask annotations.

In one embodiment, the labeling module 602 is configured to:
configure identical product identifiers for the first clothing instance and the second clothing instance.

Persons skilled in the art should understand that the function of each module in the neural network training apparatus in the embodiments can be understood by referring to the related description of the neural network training method.

FIG. 7 is a schematic structural composition diagram of an image matching apparatus provided in the embodiments of the present application. As shown in FIG. 7, the apparatus includes:
a receiving module 701, configured to receive a third clothing image to be matched;
an extracting module 702, configured to extract a third clothing instance from the third clothing image and to acquire annotation information of the third clothing instance;
a matching module 703, configured to query a matched fourth clothing instance based on the annotation information of the third clothing instance.

In one embodiment, the extracting module 702 is further configured to perform feature extraction on the third clothing image before extracting the third clothing instance from the third clothing image.

In one embodiment, the extracting module 702 is configured to acquire a key point, a clothing category, a clothing bounding box, and a segmentation mask annotation of the third clothing instance

In one embodiment, the matching module 703 is configured to determine, based on the annotation information of the third clothing instance and the annotation information of at least one clothing instance to be queried, similarity information between the third clothing instance and the each clothing instance to be queried; and
to determine the fourth clothing instance matching the third clothing instance based on the similarity information between the third clothing instance and the each clothing instance to be queried.

Persons skilled in the art should understand that the function of each module in the image matching apparatus in the embodiments of the present application can be understood by referring to the related description of the image matching method.

In the embodiments of the present application, the image dataset, the labeled annotation information, and the matching relationship can be stored in a computer-readable storage medium, implemented in the form of software functional modules, and sold or used as independent products.

The technical solutions in the embodiments of the present application or a part thereof contributing to the prior art may be essentially represented in the form of a software product. The computer software product is stored in one storage medium and includes several instructions so that one computer device (which may be a personal computer, a server, a network device, and the like) implements all or a part of the method in the embodiments of the present application. Moreover, the preceding storage medium includes media storing program codes such as a USB flash drive, a mobile hard disk, a Read-only Memory (ROM), a floppy disk, and an optical disc. In this way, the embodiments of the present application are not limited to any combination of particular hardware and software.

Correspondingly, the embodiments of the present application further provide a computer program product having computer executable instructions stored thereon, where when the computer executable instructions are executed, a tracking system initialization method in the embodiments of the present application can be implemented.

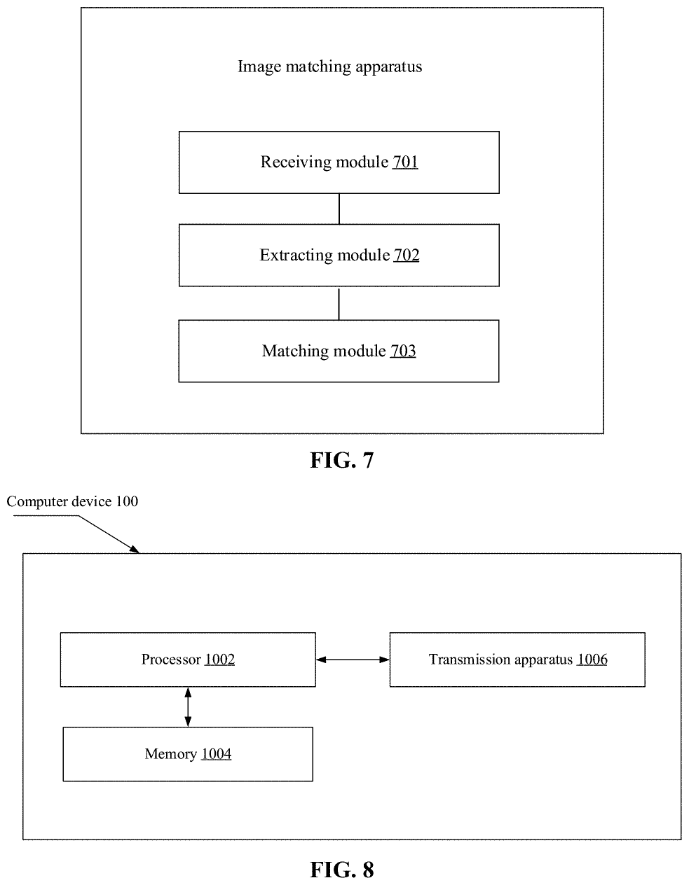

FIG. 8 is a schematic structural composition diagram of a computer device according to the embodiments of the present application. As shown in FIG. 8, a computer device 100 can include one or more (only one shown in the drawing) processors 1002 (the processor 1002 can include but not limited to processing apparatuses such as a Micro Controller Unit (MCU) and a Field Programmable Gate Array (FPGA)), a memory 1004 configured to store data, and a transmission apparatus 1006 configured to communicate. Persons skilled in the art can understand that the structure shown in FIG. 8 is merely exemplary, and does not limit the structure of the electronic device above. For example, the computer device 100 may further include more or less components than those shown in FIG. 8, or has configurations different from those shown in FIG. 8.

The memory 1004 may be configured to store a software program of application software and modules, such as program instructions/modules corresponding to the methods according to the embodiments of the present application. The processor 1002 runs the software program stored on the memory 1004 and the modules so as to implement function applications and data processing, i.e., implementing the methods. The memory 1004 may include high-speed random memories and may also include non-volatile memories such as one or more magnetic storage apparatuses, flashes, or other non-volatile solid memories. In some embodiments, the memory 1004 may further include memories remotely provided relative to the processor 1002. These remote memories may be connected to the computer device 100 via a network. Instances of the network above include but not limited to Internet, Intranet, local area network, a mobile communication network, and a combination thereof.

The transmission apparatus 1006 is configured to receive or transmit data via one network. The specific instances of the network above may include wireless networks provided by a communication provider of the computer device 100. In one embodiment, the transmission apparatus 1006 includes one Network Interface Controller (NIC) connected to other network devices via a base station to communicate with Internet. In one embodiment, the transmission apparatus 1006 may be a Radio Frequency (RF) module configured to communicate with Internet in a wireless manner.

The technical solutions recited in the embodiments of the present application can be arbitrarily combined without causing conflicts.

It should be understood that the disclosed methods and smart devices in the embodiments provided in the present application may be implemented by other modes. The device embodiments described above are merely exemplary. For example, the unit division is merely logical function division and may be actually implemented by other division modes. For example, a plurality of units or components may be combined or integrated into another system, or some features may be ignored or not performed. In addition, the displayed or discussed mutual couplings or direct couplings or communication connections among the components may be implemented by means of some interfaces. The indirect couplings or communication connections between the devices or units may be implemented in electronic, mechanical, or other forms.

The units described as separate components may or may not be physically separate, and the components displayed as units may or may not be physical units, may be located at one position, or may be distributed on a plurality of network units. A part of or all of the units may be selected according to actual needs to achieve the objectives of the solutions of the embodiments.

In addition, the functional units in the embodiments of the present application may be integrated into one second processing unit, or each of the units may exist as an independent unit, or two or more units are integrated into one unit, and the integrated unit may be implemented in the form of hardware, or may also be implemented in the form of a hardware and software functional unit.

The descriptions above are only specific implementations of the present application. However, the scope of protection of the present application is not limited thereto. Within the technical scope disclosed by the present application, any variation or substitution that can be easily conceived of by those skilled in the art should all fall within the scope of protection of the present application.

1. A neural network training method, comprising:
labeling annotation information of a first clothing instance and a second clothing instance, wherein the first clothing instance and the second clothing instance are respectively from a first clothing image and a second clothing image;
pairing the first clothing image and the second clothing image in response to a state of matching between the first clothing instance and the second clothing instance; and
training a neural network to be trained based on the paired first clothing image and second clothing image.

2. The method according to claim 1, wherein labeling the annotation information of the first clothing instance and the second clothing instance comprises:
respectively labeling clothing bounding boxes of the first clothing instance and the second clothing instance.

3. The method according to claim 2, wherein labeling the annotation information of the first clothing instance and the second clothing instance further comprises:
respectively labeling clothing categories and key points of the first clothing instance and the second clothing instance.

4. The method according to claim 3, wherein labeling the annotation information of the first clothing instance and the second clothing instance further comprises: respectively labeling clothing outlines and segmentation mask annotations of the first clothing instance and the second clothing instance.

5. The method according to claim 4, wherein respectively labeling the clothing categories and the key points of the first clothing instance and the second clothing instance comprises:
respectively acquiring the clothing categories of the first clothing instance and the second clothing instance; and
respectively labeling the corresponding key points of the first clothing instance and the second clothing instance based on a labeling rule of the clothing categories.

6. The method according to claim 5, after the respectively labeling the clothing categories and the key points of the first clothing instance and the second clothing instance, further comprising:
labeling attribute information of each of the key points, wherein the attribute information is used for indicating whether the key point is a visible point or a blocked point.

7. The method according to claim 6, wherein labeling the annotation information of the first clothing instance and the second clothing instance further comprises:
respectively labeling edge points and intersection points of the first clothing instance and the second clothing instance, wherein the edge points are points of the clothing instances on the boundaries of clothing images, and the intersection points are points located at positions where the first clothing instance or the second clothing instance intersects other clothing instances and used for drawing the clothing outlines.

8. The method according to claim 7, wherein respectively labeling the clothing outlines of the first clothing instance and the second clothing instance comprises:
respectively drawing the clothing outlines of the first clothing instance and the second clothing instance respectively based on the key points, the attribute information of each of the key points, the edge points, and the intersection points of the first clothing instance and the second clothing instance.

9. The method according to claim 8, wherein the respectively labeling the segmentation mask annotations of the first clothing instance and the second clothing instance comprises:
respectively generating corresponding preliminary segmentation mask maps based on the clothing outlines of the first clothing instance and the second clothing instance; and
correcting the preliminary segmentation mask maps to obtain the segmentation mask annotations.

10. The method according to claim 1, wherein pairing the first clothing image and the second clothing image comprises: configuring identical product identifiers for the first clothing instance and the second clothing instance.

11. The method according to claim 1, further comprising:
obtaining a trained neural network and a third clothing image to be matched;
inputting the third clothing image to the trained neural network;
extracting a third clothing instance from the third clothing image;
acquiring annotation information of the third clothing instance; and
querying a matched fourth clothing instance based on the annotation information of the third clothing instance.

12. The method according to claim 11, before extracting the third clothing instance from the third clothing image, further comprising:
performing feature extraction on the third clothing image.

13. The method according to claim 11, wherein acquiring the annotation information of the third clothing instance comprises:
acquiring a key point, a clothing category, a clothing bounding box, and a segmentation mask annotation of the third clothing instance.

14. The method according to claim 1, wherein querying the matched fourth clothing instance based on the annotation information of the third clothing instance comprises:
determining, based on the annotation information of the third clothing instance and annotation information of at least one clothing instance to be queried, similarity information between the third clothing instance and each clothing instance to be queried; and
determining the fourth clothing instance matching the third clothing instance based on the similarity information between the third clothing instance and the each clothing instance to be queried.

15. A neural network training apparatus, comprising:
a processor;
a memory configured to store instructions executable by the processor;
wherein when the instructions are executed by the processor, the processor is configured to:
label annotation information of a first clothing instance and a second clothing instance, wherein the first clothing instance and the second clothing instance are respectively from a first clothing image and a second clothing image, and to pair the first clothing image and the second clothing image in response to a state of matching between the first clothing instance and the second clothing instance; and
train a neural network to be trained based on the paired first clothing image and second clothing image.

16. The apparatus according to claim 15, wherein the processor is further configured to:
respectively label clothing bounding boxes of the first clothing instance and the second clothing instance.

17. The apparatus according to claim 15, wherein the processor is further configured to:
obtain a trained neural network and a third clothing image to be matched;
input the third clothing image to the trained neural network;
extract a third clothing instance from the third clothing image;
acquire annotation information of the third clothing instance; and
query a matched fourth clothing instance based on the annotation information of the third clothing instance.

18. A storage medium, having computer programs stored thereon, wherein the computer programs enable a computer device to execute:
labeling annotation information of a first clothing instance and a second clothing instance, wherein the first clothing instance and the second clothing instance are respectively from a first clothing image and a second clothing image;
pairing the first clothing image and the second clothing image in response to a state of matching between the first clothing instance and the second clothing instance; and
training a neural network to be trained based on the paired first clothing image and second clothing image.

19. The storage medium according to claim 18, wherein labeling the annotation information of the first clothing instance and the second clothing instance comprises:
respectively labeling clothing bounding boxes of the first clothing instance and the second clothing instance.

20. The storage medium according to claim 18, wherein the computer programs enable the computer device to further execute:
obtaining a trained neural network and a third clothing image to be matched;
inputting the third clothing image to the trained neural network;
extracting a third clothing instance from the third clothing image;
acquiring annotation information of the third clothing instance; and
querying a matched fourth clothing instance based on the annotation information of the third clothing instance.
